(19) United States
(12) Patent Application Publication
(10) Pub. No.: US 2024/0410133 A1
(43) Pub. Date: Dec. 12, 2024

(54) ELECTRIC EXCAVATOR

(71) Applicant: KOMATSU LTD., Minato-ku, Tokyo (JP)

(72) Inventors: Hitoshi ARASE, Minato-ku, Tokyo (JP); Hayao YOSHINO, Minato-ku, Tokyo (JP); Masaho YAMAGUCHI, Minato-ku, Tokyo (JP)

(73) Assignee: KOMATSU LTD., Minato-ku, Tokyo (JP)

(21) Appl. No.: 18/702,897

(22) PCT Filed: Oct. 27, 2022
(86) PCT No.: PCT/JP2022/040139

§ 371 Date: Apr. 19, 2024

(30) Foreign Application Priority Data
Nov. 8, 2021 (JP) 2021-181613

(51) Int. Cl. E02F 9/08; B60L 50/60; E02F 9/22

(52) U.S. Cl. CPC E02F 9/0866; B60L 50/66; E02F 9/0875; E02F 9/0883; E02F 9/2278; B60L 2200/40

(57) ABSTRACT

A high voltage portion (HVP) includes an electric motor and a battery that supplies electric power to the electric motor, the high voltage portion (HVP) being a portion to be subjected to maintenance. An operator's cab is arranged on a revolving frame at a location closer to a front end of the revolving frame than the high voltage portion (HVP). A frontmost end position of the high voltage portion (HVP) is located closer to a rear end of the revolving frame than a rearmost end position of the operator's cab. A switching valve is located between the frontmost end position of the high voltage portion (HVP) and the rearmost end position of the operator's cab in a fore/aft direction.

### TECHNICAL FIELD

The present disclosure relates to an electric excavator.

### BACKGROUND ART

Conventionally, a battery-powered electric excavator has been disclosed in, for example, Japanese Patent Laying-Open No. 11-140906 (PTL 1) and Japanese Patent Laying-Open No. 2012-1933 (PTL 2). Each of PTLs 1 and 2 discloses a small-sized electric excavator in which a battery, an electric motor and a hydraulic pump are arranged in this order from a rear part toward a front part of a revolving unit.

### CITATION LIST

### Patent Literature

PTL 1: Japanese Patent Laying-Open No. 11-140906

PTL 2: Japanese Patent Laying-Open No. 2012-1933

### SUMMARY OF INVENTION

### Technical Problem

There is disclosed an electric excavator in which a battery is arranged in a rear part of a revolving unit because the battery also serves as a counterweight. However, in the case of a large-sized electric excavator, a battery is large and thus occupies a large space. Therefore, the battery protrudes into a machine compartment from the region where the battery is arranged as a counterweight. Thus, when the battery is located relatively close to an operator's cab (cab), an operator in the operator's cab or a person getting in and out of the operator's cab is likely to come into contact with a high voltage portion including the battery.

An object of the present disclosure is to provide an electric excavator with improved maintainability by separating a movement line of a person getting in and out of an operator's cab and a movement line of a person performing maintenance of a high voltage portion.

### Solution to Problem

An electric excavator according to the present disclosure includes: a revolving frame; a high voltage portion; an operator's cab; and a switching valve. The revolving frame has a front end and a rear end that face each other in a plan view. The high voltage portion includes an electric motor that serves as a motive power source and a battery that supplies electric power to the electric motor, the high voltage portion being a portion to be subjected to maintenance. The operator's cab is arranged on the revolving frame at a location closer to the front end than the high voltage portion. A first position of the high voltage portion that is closest to the front end is located closer to the rear end than a second position of the operator's cab that is closest to the rear end. The switching valve is located between the first position and the second position in a fore/aft direction in which the front end and the rear end face each other.

### Advantageous Effects of Invention

According to the present disclosure, it is possible to achieve an electric excavator with improved maintainability by separating a movement line of a person getting in and out of an operator's cab and a movement line of a person performing maintenance of a high voltage portion.

### BRIEF DESCRIPTION OF DRAWINGS

FIG. 1 is a perspective view schematically showing a configuration of an electric excavator according to an embodiment of the present disclosure.

FIG. 2 is a plan view showing a configuration of a revolving frame and arrangement of components mounted thereon in the electric excavator shown in FIG. 1.

FIG. 3 is a side view showing the configuration of the revolving frame and the arrangement of the components mounted thereon in the electric excavator shown in FIG. 1.

### DESCRIPTION OF EMBODIMENTS

Hereinafter, an embodiment of the present disclosure will be described with reference to the drawings.

In the specification and the drawings, the same or corresponding components are denoted by the same reference characters, and the description thereof will not be repeated. In the drawings, some configurations may be omitted or simplified for convenience of description.

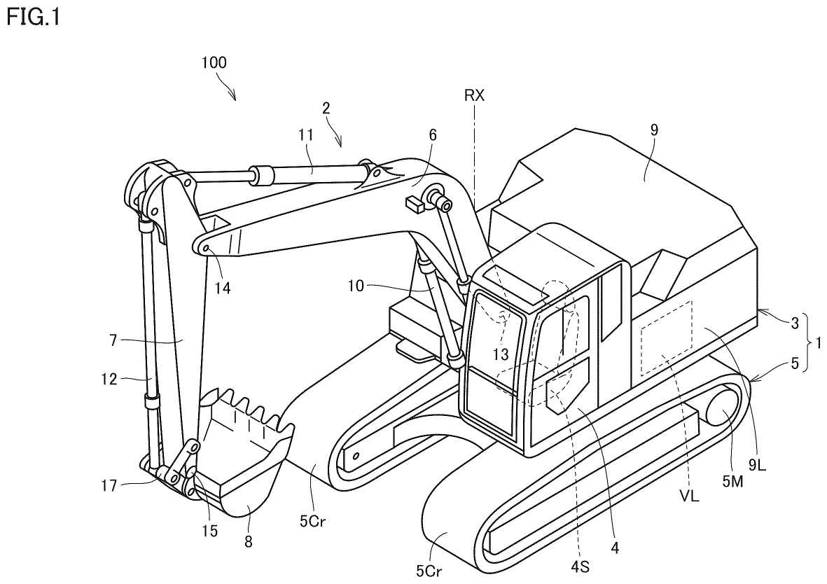

In the following description, the terms “upper”, “lower”, “front”, “rear”, “left”, and “right” indicate the directions with respect to an operator seated on an operator's seat 4S in an operator's cab 4 shown in FIG. 1. In addition, a plan view in the present specification refers to a point of view when a revolving frame 20 is viewed from above along a revolution axis RX.

### Configuration of Electric Excavator

First, a configuration of an electric excavator according to the present embodiment will be described with reference to FIG. 1.

FIG. 1 is a perspective view schematically showing a configuration of an electric excavator according to an embodiment of the present disclosure. As shown in FIG. 1, an electric excavator 100 includes a main body 1, and a work implement 2 that is hydraulically actuated. Main body 1 includes a revolving unit 3 and a traveling unit 5. Traveling unit 5 includes a pair of crawler belts 5Cr and a travel motor 5M. Electric excavator 100 can travel by rotation of crawler belts 5Cr. Travel motor 5M is provided as a driving source of traveling unit 5. Travel motor 5M is a hydraulic motor that is hydraulically actuated. Traveling unit 5 may include a wheel (tire).

Revolving unit 3 is arranged on traveling unit 5 and supported by traveling unit 5. Revolving unit 3 can revolve about a revolution axis RX with respect to traveling unit 5 by a revolving motor (not shown). The revolving motor is a hydraulic motor that is hydraulically actuated. Travel motor 5M or the revolving motor may be an electric motor. Revolution axis RX is an imaginary straight line serving as a center of revolution of revolving unit 3.

Revolving unit 3 includes operator's cab 4 (cab). Operator's seat 4S on which an operator is seated is provided in operator's cab 4. The operator (occupant) who is aboard operator's cab 4 can perform the control of work implement 2, the revolving control of revolving unit 3 with respect to traveling unit 5, and the traveling control of electric excavator 100 by traveling unit 5.

Revolving unit 3 includes an exterior cover 9. Exterior cover 9 covers a machine compartment. A battery, an inverter, a converter, an electric motor, a hydraulic pump, a revolving motor, a switching valve, a hydraulic oil tank and the like are arranged in the machine compartment.

The machine compartment refers to a space located forward of each of a rear end RL of a left deck DL and a rear end RR of a right deck DR, and covered by exterior cover 9.

Work implement 2 is supported by revolving unit 3. Work implement 2 includes a boom 6, an arm 7 and a bucket 8. Work implement 2 further includes a boom cylinder 10, an arm cylinder 11 and a bucket cylinder 12.

Boom 6 is pivotably connected to main body 1 (traveling unit 5 and revolving unit 3). Specifically, a proximal end of boom 6 is pivotably connected to revolving unit 3 about a boom foot pin 13 as a pivot point.

Arm 7 is pivotably connected to boom 6. Specifically, a proximal end of arm 7 is pivotably connected to a tip of boom 6 about a boom top pin 14 as a pivot point. Bucket 8 is rotatably connected to arm 7. Specifically, a proximal end of bucket 8 is pivotably connected to a tip of arm 7 about an arm top pin 15 as a pivot point.

One end of boom cylinder 10 is connected to revolving unit 3, and the other end thereof is connected to boom 6. Boom 6 can be driven with respect to main body 1 by boom cylinder 10. Boom 6 driven in this way can pivot about boom foot pin 13 as a pivot point in an up/down direction with respect to revolving unit 3. One end of arm cylinder 11 is connected to boom 6, and the other end thereof is

connected to arm 7. Arm 7 can be driven with respect to boom 6 by arm cylinder 11. Arm 7 driven in this way can pivot about boom top pin 14 as a pivot point in an up/down direction or a fore/aft direction with respect to boom 6.

One end of bucket cylinder 12 is connected to arm 7, and the other end thereof is connected to a bucket link 17. Bucket 8 can be driven with respect to arm 7 by bucket cylinder 12. Bucket 8 driven in this way can pivot about arm top pin 15 as a pivot point in an up/down direction with respect to arm 7.

Each of boom cylinder 10, arm cylinder 11 and bucket cylinder 12 is, for example, a hydraulic cylinder and is hydraulically driven.

### Configuration of Revolving Frame and Arrangement of Components Mounted Thereon

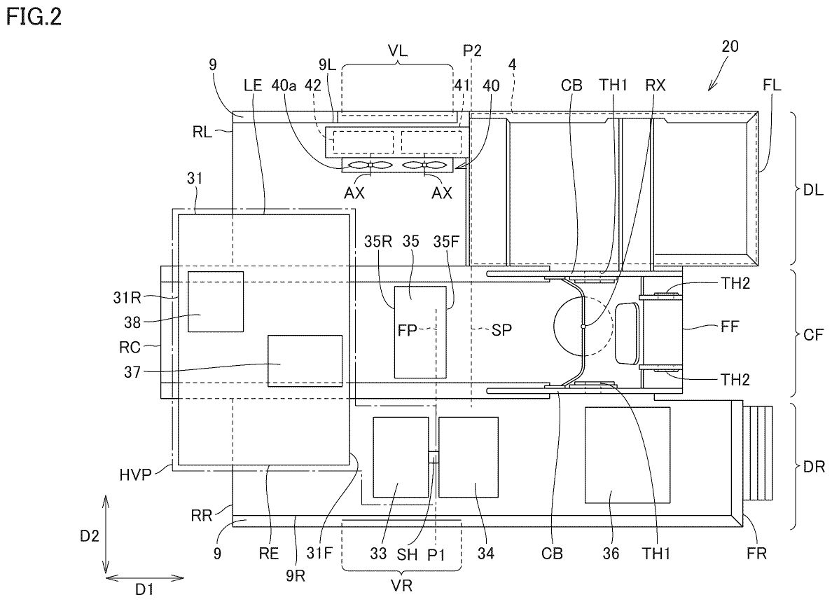

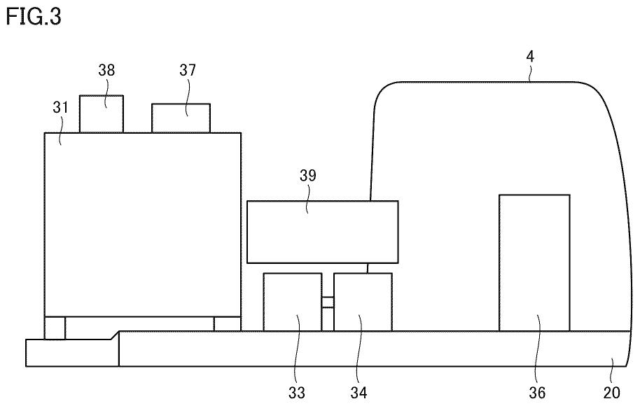

Next, a configuration of the revolving frame and arrangement of components mounted on the revolving frame in the electric excavator shown in FIG. 1 will be described with reference to FIGS. 2 and 3.

FIGS. 2 and 3 are a plan view and a side view showing a configuration of the revolving frame and arrangement of components mounted thereon in the electric excavator shown in FIG. 1, respectively. As shown in FIG. 2, revolving unit 3 (FIG. 1) includes a revolving frame 20. Revolving frame 20 revolves about revolution axis RX with respect to traveling unit 5 (FIG. 1)

Revolving frame 20 includes a center frame CF, left deck DL (first deck) and right deck DR (second deck). Each of center frame CF, left deck DL and right deck DR extends in a fore/aft direction D1. Center frame CF is located between left deck DL and right deck DR in a right/left direction D2 orthogonal to fore/aft direction D1 in a plan view. Left deck DL is arranged on the left side of center frame CF. Right deck DR is arranged on the right side of center frame CF.

Center frame CF includes a pair of center beams CB. The pair of center beams CB are arranged to be spaced apart from and face each other in right/left direction D2. The pair of center beams CB support work implement 2 (FIG. 1). Thus, center frame CF supports work implement 2.

Each of the pair of center beams CB includes through holes TH1 and TH2. Boom foot pin 13 (FIG. 1) is inserted through through hole TH1. Boom foot pin 13 allows boom 6 (FIG. 1) to be rotatably supported by the pair of center beams CB.

A pin (not shown) that supports boom cylinder 10 (FIG. 1) is inserted through through hole TH2. This pin allows boom cylinder 10 to be rotatably supported by center beams CB.

Revolving frame 20 has a front end and a rear end that face each other in the fore/aft direction in a plan view. The front end of revolving frame 20 is constituted of a front end FL of left deck DL, a front end FR of right deck DR, and a front end FF of center frame CF. The rear end of revolving frame 20 is constituted of rear end RL of left deck DL, rear end RR of right deck DR, and a rear end RC of center frame CF.

Each of front end FL of left deck DL and front end FR of right deck DR is located forward of front end FF of center frame CF in fore/aft direction D1. Rear end RC of center frame CF is located rearward of rear end RL of left deck DL and rear end

RR of right deck DR in fore/aft direction D1. Rear end RC of center frame CF is a rearmost end of center frame CF.

The components such as operator's cab 4, a high voltage portion HVP (region indicated by a one-dot chain line in the figure) that is a portion to be subjected to maintenance, a hydraulic pump 34, a switching valve 35, and a hydraulic oil tank 36 are mounted on revolving frame 20. High voltage portion HVP that is a portion to be subjected to maintenance includes a battery 31, an electric motor 33, an inverter, a high voltage thermal management system 37, and a power distribution unit 38. High voltage portion HVP that is a portion to be subjected to maintenance does not include a charge port and a battery thermal management system.

Battery 31 includes, for example, a plurality of battery modules. Each of the plurality of battery modules includes a plurality of battery cells. Battery 31 is a power source and stores electric energy obtained from an external power source. Battery 31 takes out the stored electric energy as electromotive force. Battery 31 supplies electric power to the inverter through electric wiring.

Electric excavator 100 according to the present embodiment does not include a counterweight and battery 31 serves as a counterweight. Therefore, battery 31 is arranged in a rear part of revolving unit 3.

A region located rearward of each of rear end RL of left deck DL and rear end RR of right deck DR is essentially a region where a counterweight is arranged. Battery 31 includes a portion located rearward of each of rear end RL of left deck DL and rear end RR of right deck DR (portion located farther from the front end of revolving frame 20) in a plan view so as to serve as a counterweight. Therefore, a rear end 31R of battery 31 is located rearward of each of rear end RL of left deck DL and rear end RR of right deck DR in fore/aft direction DI in a plan view.

However, in the case of large-sized electric excavator 100, battery 31 is also large. When the height of battery 31 becomes higher, the rear visibility of the operator seated in operator's seat 4S becomes worse. Therefore, battery 31 cannot be entirely housed within the region where the counterweight is arranged, and protrudes into the machine compartment. Therefore, a front end 31F of battery 31 includes a portion located forward of each of rear end RL of left deck DL and rear end RR of right deck DR (portion located closer to the front end of revolving frame 20) in a plan view. As battery 31 protrudes into the machine compartment in this way, the arrangement of the components other than battery 31 is limited.

In a plan view, a left end LE of battery 31 is located directly above left deck DL and a right end RE of battery 31 is located directly above right deck DR.

The inverter converts a direct current, which is an output of battery 31, into an alternating current having a controlled frequency or the like. The inverter supplies AC power to electric motor 33 through electric wiring. The inverter thereby controls driving of electric motor 33. In this way, the electric energy stored in battery 31 is supplied to electric motor 33.

Electric motor 33 is driven by the AC power supplied from the inverter, using battery 31 as a power source. The rotation speed of electric motor 33 is controlled in accordance with the frequency of the AC power supplied from the inverter. An output shaft SH of electric motor 33 is mechanically connected to an input shaft of hydraulic pump 34. When electric motor 33 is driven, the driving force of electric motor 33 is transmitted to hydraulic pump 34 and hydraulic pump 34 is driven. Electric motor 33 is located forward of battery 31 in fore/aft direction D1. In other words, electric motor 33 is located closer to the front end of revolving frame 20 than battery 31 in fore/aft direction D1. Electric motor 33 is supported by right deck DR.

High voltage thermal management system 37 is a box including a high voltage wiring and a safety device. Power distribution unit 38 has the function of distributing the electric power stored in battery 31 to the devices (such as, for example, the inverter and a DC/DC converter). Each of high voltage thermal management system 37 and power distribution unit 38 is, for example, arranged directly above battery 31, and is a high voltage device.

As shown in FIG. 3, a battery thermal management system 39 is a temperature adjustment device that monitors and controls a rise in temperature of battery 31, and cools high voltage portion HVP. Battery thermal management system 39 is, for example, arranged directly above electric motor 33.

Battery thermal management system 39 requires regular maintenance. Since battery thermal management system 39 is arranged directly above electric motor 33, the installation height of battery thermal management system 39 can be made lower, as compared with when battery thermal management system 39 is arranged directly above battery 31. This leads to better access to battery thermal management system 39 and makes maintenance easier.

As shown in FIG. 2, operator's cab 4 is placed on revolving frame 20 at a location closer to the front end of revolving frame 20 than high voltage portion HVP. Operator's cab 4 is placed on the front end of left deck DL. In fore/aft direction D1, a frontmost end position FP of high voltage portion HVP is located rearward of a rearmost end position SP of operator's cab 4. In other words, frontmost end position FP of high voltage portion HVP is located closer to the rear end of revolving frame 20 than rearmost end position SP of operator's cab 4. Frontmost end position FP of high voltage portion HVP is, for example, a front end position of output shaft SH of electric motor 33.

Fore/aft direction DI corresponds to a direction in which the front end and the rear end of revolving frame 20 face each other. Right/left direction D2 corresponds to a direction orthogonal to fore/aft direction D1 in a plan view. Frontmost end position FP of high voltage portion HVP corresponds to a first position P1 of high voltage portion HVP that is closest to the front end of revolving frame 20. Rearmost end position SP of operator's cab 4 corresponds to a second position P2 of operator's cab 4 that is closest to the rear end of revolving frame 20.

Hydraulic pump 34 driven supplies a hydraulic oil to each of the hydraulic actuators (travel motor 5M, the revolving motor and hydraulic cylinders 10 to 12) through switching valve 35 (main valve). Specifically, hydraulic pump 34 driven pumps out the hydraulic oil from hydraulic oil tank 36 through a hydraulic pipe. Hydraulic oil tank 36 serves to supply the oil to hydraulic pump 34. The hydraulic oil discharged from hydraulic pump 34 is supplied to switching valve 35 through the hydraulic pipe. Hydraulic pump 34 is located forward of electric motor 33 in fore/aft direction D1. In other words, hydraulic pump 34 is located closer to the front end of revolving frame 20 than electric motor 33 in fore/aft direction D1. Hydraulic pump 34 is supported by right deck DR.

Switching valve 35 is formed as an assembly of multiple control valves, pilot valves and the like. Switching valve 35 is arranged in an oil path (hydraulic pipe) between hydraulic pump 34 and each of the hydraulic actuators. Switching valve 35 supplies and discharges the hydraulic oil pumped out from hydraulic oil tank 36 by hydraulic pump 34 to and from each of the hydraulic actuators. Each of the hydraulic actuators is actuated by supply and discharge of the hydraulic oil by switching valve 35.

Opening and closing of each valve in switching valve 35 are controlled in accordance with the operation control by the operator. Main body 1 and work implement 2 of electric excavator 100 can thereby be actuated in accordance with the operation control by the operator who is aboard operator's cab 4. Specifically, the operator can control work implement 2 by actuating hydraulic cylinders 10 to 12, can control revolution of revolving unit 3 by actuating the revolving motor, and can control traveling of electric excavator 100 by actuating travel motor 5M.

Switching valve 35 is supported by center frame CF. Switching valve 35 includes a portion located between frontmost end position FP of high voltage portion HVP and rearmost end position SP of operator's cab 4 in fore/aft direction D1. A frontmost end position 35F of switching valve 35 is located forward of frontmost end position FP of high voltage portion HVP, and is located rearward of rearmost end position SP of operator's cab 4. In addition, a rearmost end position 35R of switching valve 35 is located rearward of frontmost end position FP of high voltage portion HVP.

In the present embodiment, each of electric motor 33, hydraulic pump 34 and hydraulic oil tank 36 is supported by right deck DR. Each of electric motor 33, hydraulic pump 34 and hydraulic oil tank 36 is arranged forward (on the front end FR side of right deck DR) of battery 31.

Electric motor 33, hydraulic pump 34 and hydraulic oil tank 36 are arranged in this order from the rear end RR side to the front end FR side of right deck DR. In other words, electric motor 33 is arranged forward of battery 31, hydraulic pump 34 is arranged forward of electric motor 33, and hydraulic oil tank 36 is arranged forward of hydraulic pump 34. A charge port (not shown) may be arranged forward of hydraulic oil tank 36.

In a plan view, gaps are provided between front end 31F of battery 31 and a rear end of electric motor 33 and between a front end of hydraulic pump 34 and a rear end of hydraulic oil tank 36.

A rear end of hydraulic pump 34 is located rearward (on the rear end RR side of right deck DR) of rearmost end position SP of operator's cab 4 in fore/aft direction D1. The front end of hydraulic pump 34 is located forward (on the front end FR side of right deck DR) of rearmost end position SP of operator's cab 4 in fore/aft direction D1.

A cooling device 40, an oil cooler 41, a radiator 42 and the like may be supported by revolving frame 20. Cooling device 40 includes, for example, four cooling fans 40a. Two cooling fans 40a are arranged in the up/down direction and two cooling fans 40a are arranged in the fore/aft direction, such that a total of four cooling fans 40a are arranged.

Exterior cover 9 has a left side panel 9L. Left side panel 9L is provided with a vent VL. Vent VL is a through hole provided in left side panel 9L and is, for example, a rectangular through hole with a net attached thereto. Vent VL may be a plurality of through holes formed by punching out a material such as metal, for example, perforated metal.

Exterior cover 9 has a right side panel 9R. Right side panel 9R is provided with a vent VR. Vent VR is a through hole provided in right side panel 9R. Vent VR is a plurality of through holes formed by punching out a material such as metal, for example, perforated metal.

Left side panel 9L and right side panel 9R of exterior cover 9 face each other in right/left direction D2. Vent VL provided in left side panel 9L, and vent VR provided in right side panel 9R face each other in right/left direction D2.

Each of cooling device 40, oil cooler 41, and radiator 42 is arranged within the area linearly connecting vent VL and vent VR. Battery 31, switching valve 35, electric motor 33, and hydraulic pump 34 are also arranged within the area linearly connecting vent VL and vent VR.

Each of cooling device 40, oil cooler 41 and radiator 42 is arranged on left deck DL in a rear part of operator's cab 4, for example. Each of oil cooler 41 and radiator 42 is positioned side-by-side with cooling device 40 in right/left direction D2. Cooling device 40 in a plan view is arranged facing the area located between battery 31 and switching valve 35 in right/left direction D2. Note that each of cooling device 40, oil cooler 41 and radiator 42 may be arranged, for example, on right deck DR.

Cooling device 40 flows air between vent VL and vent VR by driving a plurality of cooling fans 40a. Cooling device 40, driven by the plurality of cooling fans 40a, allows air taken in from the exterior to the interior of the machine compartment through vent VL to pass through a space located between battery 31 and switching valve 35, and then, be discharged from the interior to the exterior of the machine compartment through vent VR, for example. Thus, the air taken in from the exterior to the interior of the machine compartment through vent VL passes through the space located between a front surface of battery 31 and a rear surface of switching valve 35, and is discharged from the interior to the exterior of the machine compartment through vent VR.

Cooling device 40, driven by the plurality of cooling fans 40a, may allow air taken in from the exterior to the interior of the machine compartment through vent VR to pass through the space between battery 31 and switching valve 35, and then, be discharged from the interior to the exterior of the machine compartment through vent VL, for example.

A partitioning member (not shown) may be arranged between battery 31 and switching valve 35. The partitioning member achieves separation between battery 31 and switching valve 35 in fore/aft direction D1. By providing the partitioning member, heating of switching valve 35 by heat of battery 31 is suppressed.

A rotation axes AX of cooling fans 40a of cooling device 40 extend in a direction that linearly connects vent VL and vent VR (the direction from vent VL to vent VR). Rotation axis AX, for example, extends along right/left direction D2. However, rotation axes AX of cooling fans 40a may be inclined with respect to right/left direction D2 in a plan view.

At least part of cooling device 40 faces vent VR without any obstacle therebetween. This allows at least part of the air delivered from cooling device 40 to move linearly without colliding with obstacles, reach vent VR, and be discharged through vent VR.

Cooling fan 40a at the front row in cooling device 40 is arranged facing each of switching valve 35, electric motor 33 and hydraulic pump 34 in right/left direction D2. This allows part of the air delivered from cooling device 40 to move linearly from cooling device 40 and directly hit each of switching valve 35, electric motor 33 and hydraulic pump 34.

Cooling fan 40a at the rear row in cooling device 40 is arranged facing battery 31 in the right/left direction. This allows part of the air delivered from cooling device 40 to move linearly from cooling device 40 and directly hit battery 31.

Oil cooler 41 is, for example, a device for cooling the hydraulic oil used to actuate each of the hydraulic actuators (travel motor 5M, the revolving motor and each of hydraulic cylinders 10 to 12). Oil cooler 41 has, for example, a tube through which the hydraulic oil passes, and a fin attached to the tube.

Radiator 42 is a device for cooling the cooling medium (e.g., cooling water) for, for example, battery 31, electric motor 33, and the inverter. Radiator 42 has, for example, a tube through which the cooling medium passes, and a fin attached to the tube.

Oil cooler 41 and radiator 42 are aligned with each other in the fore/aft direction. Oil cooler 41 is located forward of radiator 42. Oil cooler 41 is arranged facing switching valve 35 in the direction in which rotation axis AX of cooling fan 40a extends, and is positioned side-by-side with switching valve 35 in right/left direction D2. Oil cooler 41 is, for example, arranged facing cooling fan 40a at the front row in cooling device 40 in right/left direction D2.

Radiator 42 is arranged facing battery 31 in the direction in which rotation axis AX of cooling fan 40a extends, and is positioned side-by-side with battery 31 in right/left direction D2. Radiator 42 is, for example, arranged facing cooling fan 40a at the rear row in cooling device 40 in right/left direction D2.

Each of oil cooler 41 and radiator 42 may be arranged opposite to left side panel 9L with respect to cooling device 40. In other words, cooling device 40 may be arranged between vent VL and each of oil cooler 41 and radiator 42.

### Effects

Next, effects of the present embodiment will be described.

In the present embodiment, as shown in FIG. 2, switching valve 35 is located between frontmost end position FP of high voltage portion HVP and rearmost end position SP of operator's cab 4 in fore/aft direction D1. Since high voltage portion HVP is at a distance from operator's cab 4 in fore/aft direction D1 as described above, an operator in operator's cab 4 or a person getting in and out of operator's cab 4 is less likely to come into contact with high voltage portion HVP. By achieving separation between the hydraulic devices and the high voltage devices, it becomes less likely that a service engineer comes into contact with high voltage portion HVP during maintenance of the hydraulic devices. Thus, it is possible to achieve an electric excavator with improved maintainability by separating a movement line of a person getting in and out of operator's cab 4 and a movement line of a person performing maintenance of the high voltage portion.

In addition, in the present embodiment, as shown in FIG. 2, center frame CF supporting switching valve 35 is arranged between left deck DL supporting operator's cab 4 and right deck DR supporting electric motor 33. Since electric motor 33 is at a distance from operator's cab 4 in right/left direction D2 as described above, an operator in operator's cab 4 or a person getting in and out of operator's cab 4 is less likely to come into contact with high voltage portion HVP including electric motor 33.

In addition, in the present embodiment, as shown in FIG. 2, hydraulic pump 34 is supported by right deck DR at a location closer to the front end (front end FR of right deck DR) of revolving frame 20 than electric motor 33. Thus, hydraulic pump 34 can be arranged near electric motor 33, which makes connection between hydraulic pump 34 and electric motor 33 through a rotation shaft easier.

In addition, in the present embodiment, as shown in FIG. 2, cooling device 40 is arranged between operator's cab 4 and battery 31 in fore/aft direction D1. Thus, battery 31 can be cooled by cooling device 40. Therefore, a rise in temperature of the hydraulic devices such as switching valve 35 by heat generated by battery 31 is suppressed.

In addition, in the present embodiment, as shown in FIG. 2, battery 31 includes a portion located rearward of the rear end (rear end RL of left deck DL and rear end RR of right deck DR) of revolving frame 20. In other words, battery 31 includes a portion located farther from the front end (front end FL of left deck DL and front end FR of right deck DR) of revolving frame 20 than the rear end of revolving frame 20. Thus, battery 31 serves as a counterweight.

In addition, battery 31 includes a portion located forward of the rear end of revolving frame 20. In other words, battery 31 includes a portion located closer to the front end of revolving frame 20 than the rear end of revolving frame 20. Thus, battery 31 can be increased in size to such an extent that battery 31 can be housed within the machine compartment of electric excavator 100.

In addition, in the present embodiment, as shown in FIG. 2, hydraulic oil tank 36 is arranged at a location closer to the front end (front end FR of right deck DR) of revolving frame 20 than electric motor 33. Thus, separation between a region where high voltage portion HVP is arranged and a region where hydraulic oil tank 36 is arranged in fore/aft direction D1 in a plan view can be achieved.

In addition, in the present embodiment, as shown in FIG. 3, battery thermal management system 39 is arranged directly above electric motor 33. Thus, the installation height of battery thermal management system 39 can be made lower, as compared with when battery thermal management system 39 is arranged directly above battery 31, which makes maintenance of battery thermal management system 39 easier.

It should be understood that the embodiment disclosed herein is illustrative and non-restrictive in every respect. The scope of the present disclosure is defined by the terms of the claims, rather than the description above, and is intended to include any modifications within the scope and meaning equivalent to the terms of the claims.

### REFERENCE SIGNS LIST

1 main body; 2 work implement; 3 revolving unit; 4 operator's cab; 4S operator's seat; 5 traveling unit; 5Cr crawler belt; 5M travel motor; 6 boom; 7 arm; 8 bucket; 9 exterior cover; 10 boom cylinder; 11 arm cylinder; 12 bucket cylinder; 13 boom foot pin; 14 boom top pin; 15 arm top pin; 17 bucket link; 20 revolving frame; 31 battery; 31F, FF, FL, FR front end; 31R, RC, RL, RR rear end; 33 electric motor; 34 hydraulic pump; 35 switching valve; 36 hydraulic oil tank; 37 high voltage thermal management system; 38 power distribution unit; 39 battery thermal management system; 100 electric excavator; BP bottom plate; CB center beam; CF center frame; D1 fore/aft direction; D2 right/left direction; DL left deck; DR right deck; HVP high voltage portion; LE left end; Pl first position; P2 second position; RE right end; RX revolution axis; SH output shaft; TH1, TH2 through hole.

1. An electric excavator comprising:
a revolving frame having a front end and a rear end that face each other in a plan view;
a high voltage portion including an electric motor that serves as a motive power source and a battery that supplies electric power to the electric motor, the high voltage portion being a portion to be subjected to maintenance;
an operator's cab arranged on the revolving frame at a location closer to the front end than the high voltage portion,
a first position of the high voltage portion that is closest to the front end being located closer to the rear end than a second position of the operator's cab that is closest to the rear end; and
a switching valve located between the first position and the second position in a fore/aft direction in which the front end and the rear end face each other.

2. The electric excavator according to claim 1, wherein
the revolving frame includes:
a first deck that supports the operator's cab;
a second deck that supports the electric motor; and
a center frame located between the first deck and the second deck in a right/left direction orthogonal to the fore/aft direction in a plan view, the center frame supporting the switching valve.

3. The electric excavator according to claim 2, further comprising
a hydraulic pump driven by the electric motor, wherein
the hydraulic pump is supported by the second deck at a location closer to the front end than the electric motor.

4. The electric excavator according to claim 1, further comprising
a cooling device arranged between the operator's cab and the battery in the fore/aft direction.

5. The electric excavator according to claim 1, wherein
the battery includes a portion located farther from the front end than the rear end of the revolving frame, and a portion located closer to the front end than the rear end of the revolving frame.

6. The electric excavator according to claim 1, further comprising
a hydraulic oil tank arranged closer to the front end than the electric motor.

7. The electric excavator according to claim 1, further comprising
a temperature adjustment device that cools the high voltage portion, wherein
the temperature adjustment device is arranged directly above the electric motor.
